(19) United States
(12) Patent Application Publication
(10) Pub. No.: US 2013/0173368 A1
(43) Pub. Date: Jul. 4, 2013

(54) SYSTEM AND METHODS FOR POPULARITY AND INFLUENCE INDICATORS AND COMMERCIAL INCENTIVES BASED ON OBJECT-RELATED SOCIAL NETWORK REFERRALS

(71) Applicants: Gregory Boutin, Toronto (CA); Yang Han, Toronto (CA)

(72) Inventors: Gregory Boutin, Toronto (CA); Yang Han, Toronto (CA)

(21) Appl. No.: 13/632,158

(22) Filed: Oct. 1, 2012

Related U.S. Application Data
(60) Provisional application No. 61/540,902, filed on Sep. 29, 2011.

(51) Int. Cl. G06F 17/30

(52) U.S. Cl. CPC G06F 17/30283
USPC 705/14.16; 707/736

(57) ABSTRACT

The present invention generally relates to popularity indicators, influence measures, and purchase incentives. More particularly, but not by way of limitation, the present invention relates to assessing and communicating the popularity or relative popularity of objects such as songs, books, documents, pictures, web links, comments, authors, artists, creators, based on either the number of user profiles with whom an object or a reference to an object was shared on one or more social network(s) by web users, or on the number or percentage of social network connections who acted on such a referral. It also relates to measuring the influence of a web user (or group thereof) with regard to a particular object or set of objects by using the number of user profiles with whom the web user (or group thereof) shared the object(s) or a reference(s) thereto on one or more social network(s), and offering commercial incentives based on that measure.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to popularity indicators, influence measures, and purchase incentives. More particularly, but not by way of limitation, the present invention relates to assessing and communicating the popularity or relative popularity of objects such as songs, books, documents, pictures, web links, comments, authors, artists, creators, based on either the number of user profiles with whom an object or a reference to an object was shared on one or more social network(s) by web users, or on the number or percentage of social network connections who acted on such a referral. It also relates to measuring the influence of a web user (or group thereof) with regard to a particular object or set of objects by using the number of user profiles with whom the web user (or group thereof) shared the object(s) or a reference(s) thereto on one or more social network(s), and offering commercial incentives based on that measure.

### CROSS REFERENCE TO RELATED APPLICATIONS

This application claims the benefit of U.S. Provisional Patent Application No. 61540902 filed 29 Sep. 2011, the entire disclosure of which is incorporated herein by reference.

### BACKGROUND OF THE INVENTION

Popularity indicators have long been used as a way to highlight and recommend objects to consumers, professionals and other parties. In the music industry for example, they are employed to promote artists and songs to consumers by powering popularity rankings. On the Internet, applications such as Facebook (with the “Like” button), Google (with the “+1” button), Twitter (through the number of Tweets) or Digg, can display the number of users who recommended a given web page or movie actress, thus providing a measurement of popularity for that page or actress. Methodologies to produce those indicators vary greatly, depending—among other things—on the type of object being assessed, the ability of end users and experts to influence the assessment, and the extent to which the assessment is communicated through quantitative metrics or more qualitative, subjective indicators.

With the growth of the Internet and the large volume of information it gives access to, the importance of quantitative popularity indicators as a way to highlight relevant information to users, in particular, has further increased.

Quantitative popularity indicators are generally computed by measuring user activities directly related to a given object. Broadly speaking, such activities can be grouped in two categories: consuming the object (for instance, listening, reading, watching etc. . . . ) and referring it (for instance, sharing, voting, commenting, reviewing etc). Note that consumption activities can also be automatically coupled with referral activities, for example when consumption is measured or broadcasted to other users. All those activities are conducted by human agents, hereby referred to as “users” or “object users”.

A key shortcoming of current quantitative popularity indicators based on social network referral by users is that they center on the user completing the referral, not on the social network connections targeted by the user's referral. As a result, they communicate neither the social reach of referral activities nor the level of social influence of the user(s) generating the activities. The popularity counters of Facebook (“Like”), Google (“+1”), Twitter (number of tweets, as a tweet mentioning an object works as a positive or negative referral for that object) or Digg, for instance, simplistically count votes for a given object by a given user as “one vote per user”, as opposed to accounting for the number of user profiles to whom the object was referred as a result of the vote, and the number or percentage of those users who acted on that referral.

In other words, current popularity indicators fail to explicitly account for the number of people to whom an object was referred, who actually viewed the referral, and who acted on the referral for example by consuming the object. While knowing the number of referrers to an object is interesting, it is generally more useful to know how many people those referrals targeted, reached, and converted into object users.

Another shortcoming of existing quantitative popularity indicators is that users with a large or highly-relevant social reach and influence on computer-based social networks have little incentive to recommend or vote for a given object, since their activity will be counted the same as any other user including those with few or no social reach. An indicator of their referral activity using the prevalent indicators (number of social network connections, or number of objects referred) would not be object-specific and would fail to account for the number of social network connections to whom they referred the object and/or the number or percentage of social network connections who acted on that referral.

Correspondingly, current “heavy influencer” indicators are based generically on the overall number of social network connections of a user profile on social networks, and fail to provide a more specific indicator of the influence of the user with regard to a given object, such as the number of social network connections they referred the object to, or the number or percentage of social network connections that acted on such referral. Yet other current “heavy influencer” indicators are based on a weighted and often-complicated combination of measures that blur the causal relationship between a user's online actions and the measure of her influence. The Klout score, as an example of the latter type of indicator, has been subject to extensive consumer criticism about its opacity. In addition, such indicators de-couple influence measures from influence actions by collecting information after it has been shared and by measuring influence on broad topics only rather than in relation to specific concepts and objects, and as such do not directly tie the targeted action to the influence measure in order to incentivize the action.

The current absence of indicator effectively measuring and communicating the level of social reach and influence of a user with regard to a particular object, as expressed by the number of social network connections to whom the object was referred or the number or percentage of user profiles who acted on an object referral, also prevents the development of commercial incentives based on that indicator. For example, discounts are not currently based on the number of social network connections to whom the object was referred, or on the number or percentage of user profiles who acted on an object referral.

Yet another shortcoming of existing quantitative popularity indicators is that they may fare poorly in detecting future popularity among end users, because the number of referrers of an object does not reflect actual popularity among end users as tightly as the number of people which a referral targeted, reached, and converted into object users. As a result, existing indicators only play a minor role in detecting rising artists, for instance, an activity that continues to require costly, inaccurate qualitative assessments by human agents.

Qualitative indicators, for their part, address some of the issues above, but fail to concurrently quantify the social reach of the object referrals and the influence of the object referrers objectively. As such, they tend to be even more imprecise than existing quantitative popularity indicators.

Meanwhile, social networks have become more prevalent, storing information about hundreds of millions of computer users, such as their social graph, reach and influence, and making it available to third-party applications (through Application Programming Interface, i.e. APIs, for instance). As social network users become increasingly comfortable with sharing their social network data with useful applications, this data can be retrieved and used to address the issues listed above about existing popularity indicator methodologies.

### SUMMARY OF THE INVENTION

The present invention is a set of computer-based methods and systems to create, update and use a popularity indicator for an object, using the number of user profiles with whom are reference to the object was shared on one or more social network(s), and/or the number or percentage of social network connections who acted on the referral.

The invention also comprises a set of computer-based methods and systems to create, update and use a social influence indicator of a user in a relation to a particular object, based on the number of social network connections the user referred that object to, and/or the number or percentage of social network connections who acted on the referral by the user.

The invention also comprises a set of computer-based methods and computer program products to create price discount and referral incentives, using the number of social network connections the user referred an object to, and/or the number or percentage of social network connections who acted on the referral by the user.

### BRIEF DESCRIPTION OF THE DRAWINGS

FIG. 1 is a flow chart illustrating an exemplary process for creating or updating an object's popularity indicator based on an object user's social reach data from social networks, in accordance with an embodiment of the present invention;

FIG. 2 is a flow chart illustrating an exemplary process for creating or updating an object's popularity indicator based on an object user's social reach data from social networks, including multiple optional acts illustrating various embodiments of the present invention;

FIG. 3 is a high-level block diagram illustrating an apparatus for creating or updating a popularity indicator for an object, based on an object user's social reach data from social networks, in accordance with an embodiment of the present invention;

FIG. 4 is a screenshot of an exemplary interface for collecting relevant user inputs and displaying a popularity indicator generated through the methods described in FIGS. 1-2;

FIG. 5 is an example of a popularity indicator generated through the method described in FIGS. 1-2, and displayed on a webpage;

FIG. 6 is a flow chart illustrating an exemplary process for creating or updating an indicator communicating object-specific measures of a user influence, based on the number of social network connections with whom the user shared a reference to the object, in accordance with an embodiment of the present invention;

FIG. 7 is an example of indicator displaying object-specific measures of a user influence, generated through the method described in FIG. 6, and displayed on a webpage;

FIG. 8 is a flow chart illustrating an exemplary process for offering a commercial discount, based on the number of social network connections with whom the user shared a reference to the object, in accordance with an embodiment of the present invention;

FIG. 9 is a flow chart illustrating another embodiment of the process for offering a commercial discount, based on the number of social network connections with whom the user shared a reference to the object; and

FIG. 10 is an example of screen display for the commercial discounting method described in FIGS. 8-9, and communicated on a mobile webpage, in accordance with an embodiment of the present invention.

The figures depict embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION OF SPECIFIC EMBODIMENTS

### Terminology

Objects are defined as anything that can be consumed, recommended, shared, or voted upon. Examples of object types include art work, scientific work, user-generated work, commercial products, physical objects, services (e.g. travel package, concert etc), user profiles, authors, artists, creators, files (documents, music, video etc), web links, web pages, comments etc. . . . . A computer-based reference to an object may or may not include the object itself. For example, a song reference on Facebook may or may not embed the song. In an embodiment of the present invention, a computer-based object that refers to another object, such as a web link, may be considered a proxy for assessing the popularity of the object it refers to. In that embodiment, a popularity measurement for a reference to the object constitutes a usable popularity measurement for the object itself. For example, the number of social network connections to whom a link to artist's webpage has been tweeted constitutes a usable popularity measurement for the artist herself.

An object referral activity is a computer-based activity such as recommending, sharing, voting for or against an object. For example, it can be recommending or voting for an artist's webpage; sharing a link to a blog with your friends on a social network; notifying social network connections of an object consumption activity, such as listening to a song, reading a book or webpage, viewing a photograph or picture on the internet, or downloading a file. Broadly speaking, object-related activities can be sub-divided into two categories: consuming the object (for instance, listening, reading, watching, downloading, using etc. . . . ) and referring it (which can include sharing, voting, commenting, reviewing etc. . . . .) In the description of the present invention, the term object referral activity refers to the latter type. If a consumption activity is accompanied by a (manual or automated) notification to social network connections, then that notification is an object referral activity. Sharing an object directly (such as sharing a music file with social network connections) is a referral activity for the object as well.

Users refer to a person, organization, business, corporation, community, automated agent or other suitable entity that can complete an object referral activity (as defined above) through a device or computer program making use of the present invention. In the case where an object referral activity is completed automatically and triggered by some other activity by a person, that person (or organization it represents) is the user.

Social network connections refer to the profiles a user is connected with on one or more social network(s). Depending on the social network, those connections may be established explicitly, or automatically (for example by relying on an analysis of social-network activities, or because users belong to a common group). On the version of Facebook at the time of this application, a user's social network connections would be his/her “friends”. On the version of Twitter at the time of this application, they would be his or her “followers”. On the version of LinkedIn at the time of this application, they would be his or her “contacts”. Where a user is connected to several profiles of the same person on different social networks, each connection is usually regarded as a different social network connection unless otherwise specified in this description. In an embodiment of this invention, a process may first be run to assess which social network profiles belong to the same user, and collectively count those only as one social network connection per actual user for the purpose of those embodiments.

Social reach data refers to the number of social network connections of a user within or across social networks, as well as data qualifying those connections: for example to highlight that the user is connected to another person through family, through work, or through a common interest; or whether a certain social network connection acted on an object referral from the user. For example, on the social network Facebook, the social reach data of a user could include the number of friends with whom a user shared a reference to the object, as well as qualifying data to further filter the number of connections by certain criteria, e.g. to count only the social network connections who acted on the referral (for example by re-sharing it, liking it, or clicking on a link within the referral) or who hold a certain type of connection with the user (e.g. friendship, romantic relationship, business relationships, acquaintances, common interest relationship). A user's social reach data can also include information from their friends' profiles, which again may be used to count only those connections meeting certain criteria (for example, only the social network connections to whom the object was referred who live in the U.S.A.) On Twitter, the social reach data of a user could include the number of followers to whom a reference to the object was tweeted, and optionally some filtering data, such as information on whether they re-tweeted the referral or clicked on a link within it, data from the followers' Twitter profile, or information on the type of connection they have with the object user (which may be gathered from Twitter lists for example). Those examples are based on the current structure of those social networks and are susceptible to change over time, so the definition of social reach data should be interpreted conceptually, without being limited by the examples above.

### Overview

Reference will now be made in detail to specific embodiments of the invention including the best modes contemplated by the inventors for carrying out the invention.

In accordance with the present invention, the components, process acts and/or data structure may be implemented using various types of operating systems, computing platforms, computer programs and/or general purpose machines.

In various illustrative embodiments of the invention, an assessment of the popularity of an object is completed by retrieving and analyzing the number of social network connections of one or more user(s) with whom this or those user(s) shared a reference to that object on one or more computer-based social network(s). Various types of popularity indicators can then be created or updated by processing that data with a computer, optionally combining it with one or more conditions based on the data collected. The popularity indicators created can be used in various ways, for example to display a measure of popularity on a website, to create rankings of objects within or across object types.

In a preferred embodiment of the present invention, the total number of social network connections with whom a reference to an object was shared is retrieved from social networks and used to create a quantitative popularity indicator that is communicated along with the object or a reference thereto on a client device.

In addition, a social influence indicator of a user in a relation to a particular object can also be created based on the number of social network connections the user referred that object to, and/or the number or percentage of social network connections who acted on the referral by the user. That measure can be further used in various ways, for example to determine top social influencers for the object or to offer purchase or referral incentives to users.

Price discount and referral incentives can be created using the number of social network connections the user referred an object to, and/or the number or percentage of social network connections who acted on the referral by the user.

### Object Popularity Measurement Method

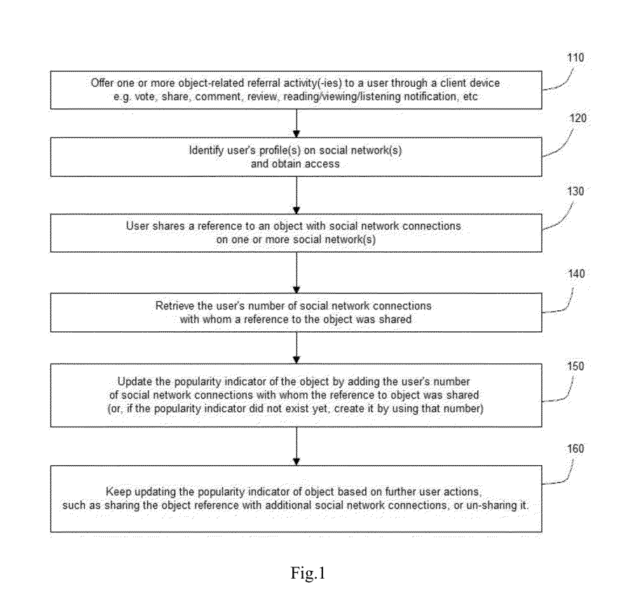

Referring now to the invention in more detail, FIG. 1 is a flow chart illustrating an exemplary process for creating or updating an object's popularity indicator based on an object user's social reach data from social networks.

At act 110, one or more computer-based referral activity(-ies) are proposed to a user through a client device 310 in relation to a given object. For example, a “Refer” button can be displayed on a mobile webpage to let a user share a link to that page on a social network such as LinkedIn; a commenting system can enable a user to write a comment about a book and broadcast that comment to her friends on Facebook; or automated notifications can be shared with a user's social network connections if the user listens to a song. Those activities can be offered on a single website, on a range of web properties and applications, or a web service linked to a database, like an Application Programming Interface (API), among others. In a preferred embodiment, relevant data from those activities must be accessible to the popularity indicator provider for the purpose of computing the popularity indicator values using the present invention. For example, the popularity indicator provider may need to record identification data for the user and the object referred to by the user, at the moment the referral action is completed or shortly thereafter, because that data may not be subsequently provided by the social network(s) on which the referral was shared. In one embodiment, the popularity indicator provider has access to that data by managing the referral activity mechanism directly, for example by letting web publishers embed code for a “Refer” button that lets the web server 330 and application server 370 of the popularity indicator provider collect, process and execute the referral activity data and instructions. Alternatively, the popularity indicator provider may also control the entire platform on which the referral activity is offered, and thus also have direct access to the related data, generally through the platform database. For example, the popularity indicator provider may control the website or a range of web properties and applications on which the activity is offered. Alternatively, if the object referral was shared on third-party social network(s), and the social network(s) share the data required by the popularity indicator provider to create and update the popularity indicator, the popularity indicator provider may not require access to the referral activity data from the platform on which the referral originated. In cases where a single user refers an object across multiple social networks however, it is anticipated that such access to the originating platform will be required in order to reconcile the referring user's identities across social networks, and unless a different mechanism is provided for such reconciliation (for example, if the user used a single open sign-up mechanism such as OpenID to register to all the social networks).

At act 120, identification credentials are obtained for the user for one or more social network(s), which can be internal to the application or a third-party social network. Identification credentials generally include a user ID, or a username or email address with a password for each of the targeted social network(s). Some data about social network connections, such as a user's followers on Twitter, do not require a password. Identification credentials can be obtained through any manual or automated method known to those skilled in the art, for example by having the user log into the social network(s) and authorize the application to access the user's private information on the social network(s), or by having the user input the identification credentials to the social networks into the application, or by having them log in through an open identification mechanism such as OpenID. Where required, express permission to access the desired user social reach data on the social network(s) may be requested from the user at that stage too. User login data can then be used to retrieve information from the social networks automatically. Identification credentials and express access permission (when collected) can be stored in the memory of web server 330 or application server 370, in data storage 380, or on a cookie 311 (subject to standard security considerations) for future retrieval. The identification method can impact what information is made available by the user and the social network(s). Note that act 120 can also occur before act 110 and/or after act 130.

At act 130, the user undertakes one or more of the referral activities proposed in act 110, thus sharing a reference to the object with social network connections on one or more social network(s). If a user attempts to refer the object on a social network to which the application does not have access, the request may either be ignored or stored for execution at a future time when access is obtained.

At act 140, a request to retrieve the social reach data of the user is sent to the social network(s) on which the object was referred. For instance, on each social network whose identification credentials were obtained in act 130, the agent can request the number of social network connections of the user with whom a reference to the object was shared. To the extent it is available, profile data for those connections such as age, interests, groups they belong to, can also be requested in order to filter the number of social network connections to whom the object was referred based on criteria relevant to the application. The request can also be limited to a specific time period, for example to retrieve only the number of social network connections with whom a referral was shared in the last 30 days. For third-party social networks, the request can be completed using a call to the Application Programming Interface (API) of that social network, or any other mechanism offered by the social network to share user data. For a social network that is internal to the application, it is often completed by a call to the database or any other data storage and retrieval method.

For example, retrieving Facebook social reach data associated with a user could be done by using the following function:

public function getFriendsCount( ){

$flist = $this−> ofb−>api(‘me/friends?access_token=’.$this−>ofb−>getAccessToken( ));
if($flist){

$flist = json_decode($flist);
return count($flist−>data);

}
return 0;

}

The initial API call retrieves a list of Facebook friends (with display name and Facebook ID for each) and assigns them to a variable. The rest counts the rows in that list in order to return the number of Facebook friends.

If the user has the ability to select the social network connections to whom the object is referred among all of their social network connections in one social network, and they choose for example to refer the object to their family members, the statement (e.g. SQL statement, API call) to retrieve the number of social connections to whom the object was referred could instead be structured as follows:

return numberPostRecipients AND PostRecipientIDs
where userID=45093 AND typeofrelationship(PostRecipientID)= “Family”
AND postID=23

In that case it would return the number of recipients whose profiles are identified as relatives of the user (with user ID 45093 on the social network) and who received the notification with post ID is 23, which is the object referral notification. Currently, the APIs of the most popular social networks do not support such detailed requests (as a business decision, not a technical one, since the technical capabilities exist). An SQL database to which access is provided would support it, assuming the information is present in the database.

Act 150 is to create or update a popularity indicator for the object, using all or some of the social reach data retrieved for the user in act 140. One or more quantitative variable(s) are generally stored in relation to the popularity indicator of a given object. The quantitative variable(s) can also be first processed into a qualitative variable (e.g. text or nominal variable) and then stored in that form. Updating the popularity indicator involves updating the stored variable(s) with data retrieved from the social network(s). In an embodiment, the number of social network connections with whom a reference to the object was shared is added to a unique variable stored in relation to the popularity indicator of the object. In another embodiment, multiple numbers of social network connections with whom a reference to the object was shared are computed, filtered through other social reach data retrieved, and then stored in different variables. As an illustration of that embodiment, two variables could be created and then updated for each object, one for storing the number of personal connections to whom the object was referred, and the other for professional connections to whom the object was referred. In another embodiment, a variable stores the overall percentage of social network connections who acted on the referral (for example by re-sharing the reference or by clicking on a link within the referral) out of all the social network connections with whom a reference to the object was shared.

When communicated, a popularity indicator can take any qualitative or quantitative form to highlight popularity level. It can take the form of a number, a simple text value (e.g. “High” or “Low”), or any type of variable or symbol suited to providing information on an object's popularity. The value is derived from one or more variable(s) stored for the popularity indicator. For example, a popularity indicator for a tablet device may be displayed as “high” if a reference to the URL showing that tablet device was shared with over 200 social network connections, “medium” between 100 and 200 connections, and “low” below 100 connections. Those thresholds could also be established dynamically, relative to the scores of other objects in the same category. The popularity indicator could also be displayed as “green”, “orange” or “red” based on score ranges. Or as the percentage of social network connections with whom a reference of the object was shared who acted on the referral, for example by clicking on a link within the referral.

As described herein, in the case of the application of a quantitative action (e.g. “adding to” or “subtracting from”) to a popularity indicator in the present invention, it is assumed that a corresponding quantitative variable is stored or processed before storage into a quantitative or qualitative variable.

In a preferred embodiment, a quantitative popularity indicator is calculated by adding to a counter the number of social network connections to whom the object was referred by the user on one or more social network(s). For example, if user A has shared a link to a song by band “ABC” on Facebook and MySpace friends and Twitter followers, the number of Facebook and MySpace friends and Twitter followers with whom the link was shared is retrieved (as authorized by user A), summed up and added to the quantitative popularity indicator of the object.

In another embodiment, the social network connections must first meet certain criteria, such as a minimum age, a common interest, or a type of relationship, to count towards the popularity indicator. In the previous example, only those user A's social network connections that are above 18 year old may be counted towards the popularity indicator for Frank Sinatra's song. One of ordinary skill in the art would appreciate that there are numerous criteria that may be utilized in this manner in accordance with embodiments of the present invention, and embodiments of the present invention are contemplated for use with any applicable criteria.

In yet another embodiment, in order to count towards a popularity indicator, the user's social network connections must themselves have undertaken an activity related to the given object, such as sharing or consuming the object (e.g. listening to the object if it is a song, reading it if it is a text etc. . . . ), and the selection can further be refined by considering object-related activities undertaken during a certain period only, e.g. the last 7 days. In the previous example, only those user A's social network connections who listened to Frank Sinatra's song or shared it with their own network may be counted toward the popularity indicator of Frank Sinatra's song.

In yet another embodiment, selection criteria on a user's social network connections can be combined with object-related activity requirements in order to compute the popularity indicator for the object. For example, only the number of user's social network connections to whom the object was referred, who are not family members of the user and who have shared the song in the past month will count towards the popularity indicator of Frank Sinatra's song.

Act 160 is to keep updating the popularity indicator of the object based on further user actions, such as sharing the object reference with additional social network connections, or un-sharing it. The object's popularity indicator can be updated dynamically, for example by monitoring changes in the number of social network connections to whom the user referred the object, or changes in the social network connections' profile data used to compute the popularity indicator (for example, if only Canadian residents counted towards the popularity indicator, any social network connection changing its residence from Canada to another country may be deducted from the variable(s) used to compute the popularity indicator). If a user “un-shares” an object previously shared on a social network, the number of social network connections with whom the object was unshared can also be updated in the computation of the popularity indicator.

The update action can be triggered by certain events, such as a user request to see the popularity indicator, or a social network notification that an item was un-shared; changes can also be monitored periodically, for example by making an API call to the social network(s) automatically every half-hour to retrieve a user's social reach data for instance including the IDs of the social network connections to whom the object was referred, and comparing that to an earlier version of the data to highlight any change.

Note that the present invention can be applied to social network profiles as objects. For instance, if a user profile has been “lilted” by Facebook users who themselves have 1,236 social network connections on Facebook, Twitter and Google+, a popularity indicator for that user profile could be 1,236. Alternatively, the popularity indicator could be some portion of that user's 1,236 connections.

The process described in FIG. 1 can be repeatedly applied to multiple users of an object. The result is an indicator of the social reach of the object's users, which is a useful reflection of the popularity of the object. When applied to multiple objects, the process produces popularity indicators for each object, which can then be used to generate a ranking of some or all of those objects.

According to an embodiment of the present invention, when the same object is referred by different users to the same social network connections, it may be counted only once towards the popularity indicator of the object. In a preferred embodiment, every referral is counted, even if made to the same social network connections.

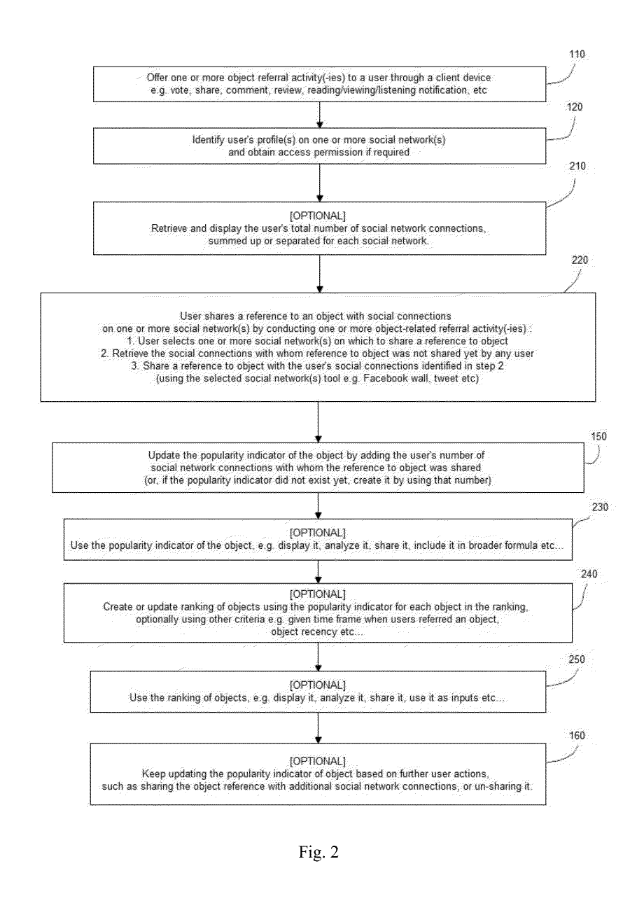

FIG. 2 is a flow chart illustrating a process for creating or updating an object's popularity indicator based on an object user's social reach data from social networks, including multiple optional acts illustrating various embodiments of the present invention.

Acts 110, 120, 150 and 160 are Explained in FIG. 1 Description Above.

At optional act 210, the number of social network connections of the user on one or more social network(s) is displayed to the user after being retrieved, to inform the user of the number by which a given object's popularity indicator could increase if the user shared a reference to that object on select social network(s). The number presented to the user can be the sum of all social network connections across all networks; or the numbers of connections on each social networks, presented separately. In another embodiment, it can be restricted by additional criteria related to the type of relationships with the user or to the social network connections' profiles. For example, the number presented could be the sum of only those social network connections with whom a reference to the object has been shared on Twitter, and who have published more than ten tweets through their Twitter profile.

Act 220 is a sharing action by the user. In the present invention, sharing a reference to an object on at least one social network is a requirement in order for the user to affect the popularity indicator of the object, and only those social network connections with whom the object was shared are counted. Sharing can be completed automatically by the application if coupled with some other activity such as consuming the object, or it can be completed using manual inputs from the user. In embodiments where the object can be shared with the user's social network connections on different social networks, an option to manually select the targeted social network(s) might be offered, as illustrated in FIG. 2 by step 1 of act 220. The user may also be given the ability to handpick which social network connections the object should be referred to—or that can be done automatically by the agent, for example by referring the object to all the user's social network connections on the selected social network(s), or by filtering them father, for instance to remove the social network connections with whom the object has already been shared (as illustrated in FIG. 2 by step 2 of act 220), or to select only connections meeting certain profile or relationship type conditions. The reference to the object is then shared with the identified social network connections (as illustrated in FIG. 2 by step 3 of act220), using the sharing mechanism in place on the selected social networks: for instance, at the time of this application, by posting a Wall note or a status update on Facebook, a tweet on Twitter, or a status update on LinkedIn.

The following Facebook API call for example would display the user's social network connections (called “friends” in Facebook) for the user to select the ones he wants to refer the object to:

// display friends for user to select
public function showFriends( ){
$flist = $this−>
ofb−>api(‘me/friends?access_token=’.$this−>ofb−>getAccessToken( ));
displayToUser($flist−>data);
}

And once the selection is made by the user, the following API call could be used to share a reference to the object with them, and return the number of social network connections it was shared with.

// share with chosen friends
public function share($flist)
{
$this−>ofb−>api(‘/me/links?access_token=’.$this−>ofb−>getAccessToken( ), ‘post’, $attachment, $flist);
return count($flist);
}

At optional act 230, the popularity indicator is used. For example, it can be displayed on the screen of a computer, tablet or mobile device, printed or mentioned verbally on a sound media. It can be shared on social networks. Popularity indicator of multiple objects can also be compared to provide an assessment of relative popularity. The evolution of a popularity indicator for a single object can be analyzed over a period of time, to assess changes in the social reach of an object. Those changes can also be compared across multiple objects, for example to detect the objects whose popularity is increasing the fastest and thereby help detect emerging artists, videos, products, songs, or any other object.

At optional act 240, objects of one or more types are ranked or sorted using their popularity indicator. If the ranking or sorting already existed, it is updated. For instance, songs can be ranked from most popular to least popular by comparing their popularity indicator values. In one embodiment, the most popular artist in the last 3 months, and across all arts, could be identified by finding the artist with the highest value in the popularity indicator variable. In an embodiment, the changes in popularity indicator values over time can be compared across objects to assess relative changes in popularity, and for example identify the comedians whose popularity is increasing the fastest. In yet another embodiment, a popularity ranking of politicians may be computed during election time by sorting those politicians by number of Twitter followers with whom the politician's names was shared by users through Tweets (i.e. short Twitter messages).

At optional act 250, the ranking or sorting created in act 240 is used, for example by being displayed on a computer screen, printed, analyzed, shared on social networks, or used as inputs into another algorithm.

### System Architecture

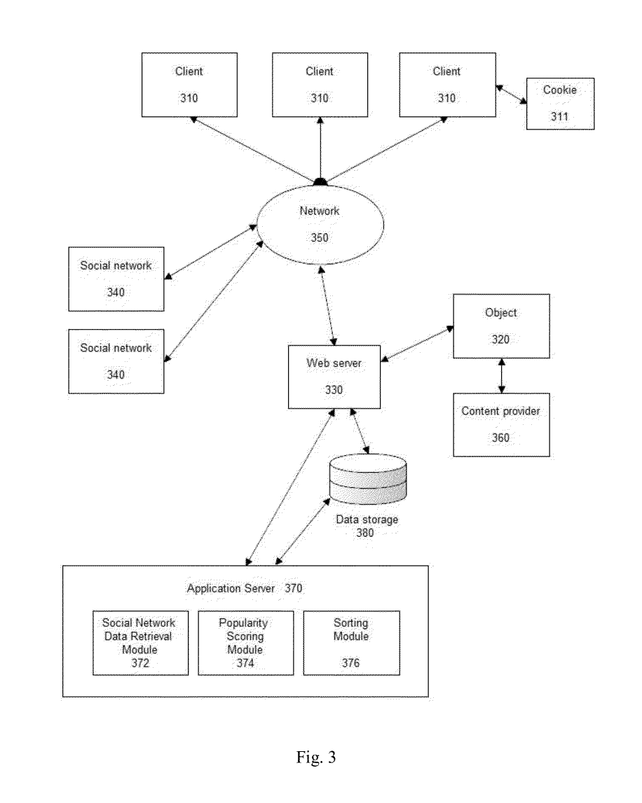

FIG. 3 is a high-level block diagram illustrating an apparatus for creating or updating a popularity indicator for an object, based on an object user's social reach data from social networks.

The web server 330 communicates with multiple client devices 310 and with social networks 340 over a network 350. Each of the client devices 310 includes an application, e.g. browser, for providing and accessing content managed by the web server. Each also include a processor, memory, network interface, display and/or audio device, a tangible computer-readable storage medium, and input devices, as well as optional peripheral devices. The processor executes computer-executable program instructions stored in the memory to access the functionality of the web server 330 and social network(s) 340. Examples of client devices 310 include personal computers, personal digital assistants, computer tablets, mobile phones, smart phones, Internet appliances and other processor-based devices. A client device 310 may be any type of processor-based device that is connected to a network 350 that comprises a browser or similar hosted application program. Client devices may operate on any operating system capable of supporting a browser-enabled application or browser, such as Windows, Android, or Mac OS. A client device may be capable of hosting one or more cookie(s) 311 for the purpose of storing data as required for future retrieval. The client devices 310 include a browser or similar application program for accessing the web server 330. The web server 330 generates and serves community webpages. It provides HTML (hypertext markup language), images, multimedia files, scripting languages (e.g. JavaScript, JScript, CSS), XSLT (extensible style sheet language transformation), and other elements that are used by a browser on a client device 310. One of ordinary skill in the art would appreciate that there are numerous components, configurations and modifications that could be utilized in accordance with embodiments of the present invention, and embodiments of the present invention are contemplated for use with any applicable components, configurations and modifications.

The network 350 enables data communication between and among the entities shown in FIG. 3. The network 350 will typically include some combination of local area networks (LAN) or wide area networks (WAN) in communication with the Internet, using standard communications technologies and/or protocols. Portions of any of these networks can be wired or wireless, using the associated technologies (e.g., Ethernet, 802.11 802.16, integrated services digital network (ISDN), digital subscriber line (DSL)), and protocols (e.g., TCP/IP, HTTP, SMTP, and FTP). The data exchanged over the network 350 can be represented using technologies and/or formats including the hypertext markup language (HTML), the extensible markup language (XML), the simple object access protocol (SOAP) and/or other formats. In addition, all or some of links can be encrypted using conventional encryption technologies such as the secure sockets layer (SSL), Internet Protocol security (Ipsec), Secure HTTP and/or virtual private networks (VPNs). In another embodiment, the entities can use custom and/or dedicated data communications technologies instead of, or in addition to, the ones described above.

The web server exchanges data with an application server 370. The application server 370 includes a social network data retrieval module 372, a popularity scoring module 374, and a sorting module 376. As used herein, the term “module” refers to logic for providing the specified functionality. A module can be implemented in hardware, firmware, and/or software. Preferably, a module is stored on the storage component of an electronic device, loaded into its memory, and executed by the device processor.

The application server 370 is coupled with data storage 380. These elements are used by the application server to process data retrieved by the web server from clients 310 and social networks 340, and to provide scoring and ranking data on object(s) 320 served by the web server 330 to clients 310 or requested from web server 330 by clients 310. Objects can be stored on the web server itself, on the client device 310 or provided by external applications such as content provider 360.

The web server 330 gathers data from client 310, social networks 340 and application server 370, and processes it to serve content back to clients 310. The web server 330 and the application server 370 may each include a dedicated server-class computer system one or more processors, memory, storage, and software applications. The functions of both servers may also be performed by a single computer system or a single server system. Alternatively, each server may individually comprise multiple computers operating under a load balancing scheme, or other mechanisms for distributing data and processes.

The web server 330 offers one or more referral activities 110 related to one or more objects 320 to a user through a client 310 over the network 350. As the user undertakes an object referral activity, the social network data retrieval module 372 requests social network identification credentials from the user (through the web server 330, the client 310 and over the network 350), or retrieve them if they were previously stored in the memory of web server 330 or application server 370, on a cookie 311, or on data storage 380 and associated with a profile in which the user has already logged in. These identification credentials are used by the social network data retrieval module 372 to retrieve the user's social reach data (e.g. the number of connections with whom the user shared a reference to the object, optionally filtered using other criteria as explained in the description for act 140) from one or more social networks 340. In a preferred embodiment, the method to retrieve that data is to use the API of each of the targeted social network(s) 340. The collected data is stored in the memory of the application server 370, on data storage 380, or through any other suitable method, such as on another web server.

Using the application server's processor(s), the popularity scoring module 374 processes the social reach data from the social network in order to compute one or more value(s) for a popularity indicator of the object. Various methods to compute or update a popularity indicator using social reach data from the object users are presented under the description of acts 150 and 160. The values associated with the popularity indicator are stored in the memory of the application server 370, on data storage 380, or through any other suitable method, such as on another web server. In an embodiment, the application server 370 conducts periodic API calls to the social network(s) 340 through the web server 330 to assess changes in the number of social network connections to whom users referred a given object, and updates the popularity indicator for that object accordingly, as presented under the description for act 160.

Optionally, for example by using the application server's processor(s), the sorting module 376 may retrieve the popularity indicators for several objects and use them to sort/rank those objects. The ranking may be computed upon request by the web server 330, or in advance and stored in the application server 370's memory, or data storage 380, or any other storage method. The data storage 380 may be implemented as one or more relational database management system (RDBMS), flat file, and/or other database architecture. Data storage elements may include any one or combination of methods for storing data, including but without limitation, arrays, hash tables, lists, and trees. Other similar types of data can be accessed by the servers 330 and 370. The data storage 380 communicates with the servers 330 and 370 by way of a network connection or any other electronic connection e.g. internal server connection if the data storage 380 is physically part of either server.

Upon request, the application server 370 sends the resulting popularity indicator(s) and/or popularity ranking(s) back to the web server 330, which processes the data for communication to client 310, which in turns communicates it to a user, for example through browser display, or to another system for further processing.

According to embodiments of the present invention, the systems described herein may be comprised of different architectures than that which is shown in FIG. 3. The system shown in FIG. 3 is merely an exemplary embodiment and is used to help explain the popularity assessment methods illustrated in FIGS. 1-2. One of ordinary skill in the art would appreciate that each of the components described herein may reside on one or more systems and be communicatively connected in a manner as to provide the functions as described herein. In certain embodiments, the whole of the invention, or portions thereof may be operable even when one or more components of the system are removed. Those of skill in the art would appreciate these variations as being of the same spirit and within the same scope of the invention described herein.

### Illustrations of Popularity Assessment Uses

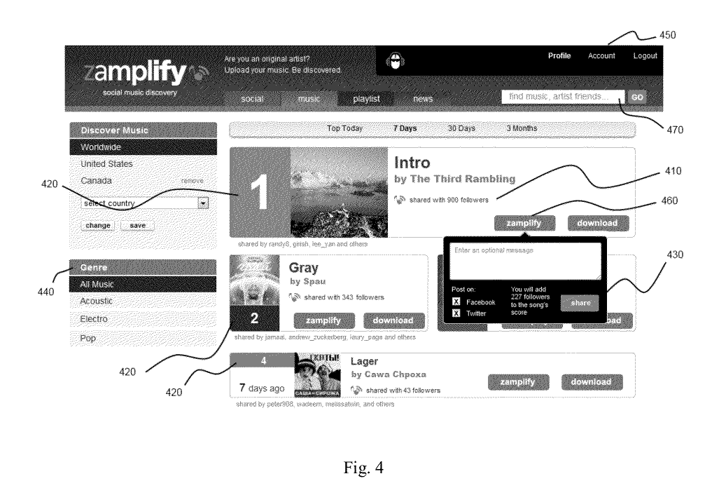

FIG. 4 is a screenshot of an exemplary interface for collecting relevant user inputs and displaying a popularity indicator generated through the method described in FIGS. 1-2.

According to an embodiment of the present invention; the web interface presented on FIG. 4 ranks songs initially uploaded by artists, or provided by an external content provider storing them on a data storage system. Instead of songs, the invention could be applied to other type of objects, including, but not limited to, books, documents, actors, webpages, people, videos, and any other suitable type of object. It can also be applied across multiple object types, for example to compare the popularity of actors versus that of singers. One of ordinary skill in the art would appreciate that there are numerous object types and combinations of object types that may be utilized in accordance with embodiments of the present invention, and embodiments of the present invention are contemplated for use with any applicable object types and combinations.

According to an embodiment of the present invention, a ranking is based on the number of social network connections to whom those songs were recommended by users on external social networks. The song with the highest number ranks first, the song with the second highest number ranks second, and so on. The ranking of each object is its ordinal position in the sorted list. In that particular example, the song ranking first is placed at the top, with the second, third and fourth songs below it. In others embodiments, the top songs could be highlighted differently, for example with a star or by being placed in a “most popular” or “hottest” section. For each song, a rank 420 and a score 410 can also be displayed next to the song and artist's names.

According to an embodiment of the present invention, users can also click on music genres 440, in which case their query is communicated to web server 330, which retrieves relevant links to the songs in a chosen music genre along with the popularity scores for those songs from data storage 380, external content provider 360, application server 370, user client 310, and/or any combination thereof or other suitable storage mechanism. The data retrieved is then processed, for example into a HTML webpage, and sent back to client 310 that displays the top songs in the selected music genre.

According to an embodiment of the present invention, the webpage includes a search interface 470 for receiving queries from members seeking content on the web application. This content can include various objects such as songs or artists. Links to the object(s) fitting the search, optionally with the popularity indicator(s) for the object(s), are retrieved by the web server 330 from data storage 380, external content provider 360, application server 370, user client 310, and/or any combination thereof or other suitable storage mechanism, and can be communicated back to the client 310 along with their popularity indicator(s) if retrieved.

An embodiment of the method described in FIGS. 1-2 is used to generate a display of a popularity indicator 410. Users can log into their account 450 before recommending the song. Their account data, retrieved from data storage 380, cookie 311 (subject to standard security considerations), or other suitable storage mechanism, may include identification credentials for external social networks such as Facebook and Twitter. Any other social network may also be offered, as long as they offer a system, e.g. API, to share users' social network connections data with external applications.

According to an embodiment of the present invention, a user may choose to recommend a particular song to her network by clicking on a recommendation button 460 (named “Zamplify” on this screenshot). As the user undertakes this object-related activity, a pop-up screen 430 is displayed, comprising selection buttons to share the object with the user's followers on external social networks Facebook and Twitter, a free text area for optional comments, an indicator of the number of social network connections with whom the recommendation will be shared, and a button to submit the information. The number of social network connections with whom the recommendation will be shared is only displayed if it could be retrieved by the web server 330 from social network(s) 340 (for example by using the user's identification credentials, or through any usual method such as username matching).

Upon submission, collected data is communicated over the network 350 to the web server 330, which passes it on to the application server 370, and to the selected social network(s) 340. The social network(s) 340 share(s) the object recommendation with the user's social network connections, and may or may not notify the web server back once that is done. According to an embodiment of the present invention, the application server 370 updates the popularity indicator 410 of the song by adding the number of social network connections with whom the recommendation was shared. In the example shown in FIG. 4, if the user was to share the top song with his 227 social network connections on Facebook and Twitter, she would add 227 points to the song's popularity indicator 410, bringing it up to a total of 900+227=1,127.

In another embodiment, the song's popularity indicator 410 could be the sum of the number of social network connections on accessible social networks for anyone listening to the song as a result of a user referral from the given website. In yet another embodiment, the song's popularity indicator 410 is the total number of users' social network connections to whom the song referral was actually displayed (just because a referral is shared, on Facebook's “Wall” for example, does not mean it is seen—a social network connection may not check their Wall for some time).

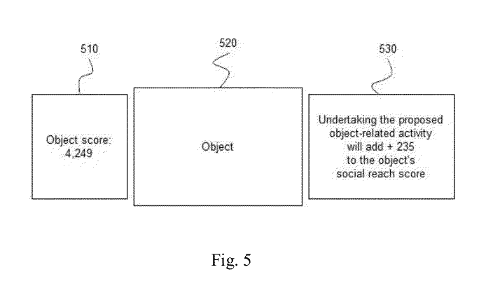

FIG. 5 is an exemplary embodiment of a popularity indicator generated through the method described in FIGS. 1-2, and displayed on a webpage.

Object score 510 is a popularity indicator for an object, based on social reach data of the object users during a defined period. The object score can be the total number of social network connections to whom an object was referred to, optionally meeting additional criteria based on their relationships with the user or social network profiles if accessible (e.g. minimum age, or type of social network connection). It can also be the percentage of social network connections of the object users who acted on the object referral by the users, for example by buying the object as a result or “lacing” the referral if in Facebook. In the example shown in FIG. 5, the score is 4,249. In other embodiments, and not by way of limitation, it may be displayed as a text expression, a symbol or a graph. It could also be communicated through audio instead of screen display.

Object 520 is a computer-based object or computer-based reference to an object, as previously described in the terminology note for “object”. For example, it could be an online video, a link to cars for sale, to fashion designers' Facebook pages, or any other object or online reference to an object.

Box 530 shows the change in the object score if the user was to undertake the proposed object referral activity (or one of the proposed activities if there are more than one). In the example shown in FIG. 5, the score would increase by 235, which for example could be the number of social network connections in the user's social reach data from social network MySpace.

With the present invention, the social reach of an object's user(s) is used to create an explicit indicator of popularity and social reach for the object, based on the number of social network connections with whom are reference to an object was shared. No existing computer-based popularity indicator provides this information. Some existing indicators mention the number of times an object was shared, but they do that by counting the number of users who shared the object instead of the number of social network connections they shared it with. For example, in the particular instance of vote-based indicators, such as those used by websites like Digg (with the “Digg it” button), Facebook (with the “Like” button) or Google (with the “+1” button), votes for a given object by a user are counted as “one vote per voter” and the total number of votes is sometimes displayed. Existing quantitative methodologies weigh highly influential users of an object the same as users with little social reach. Using an embodiment of the present invention, those methodologies could instead be made to offer +X voting buttons, where X is the number of social network connections to whom the user refers the object on one or more social network(s), and X gets added to the object's vote counter when a user votes, instead of just 1.

Using the present invention, one can display popularity indicators that are often more interesting or more predictive than existing ones, such as the total number of social network connections with whom an object was shared by users, or the total number of social network connections of the object users who acted on a referral, among others. As a result, the popularity indicator reflects the social reach and influence of the object's users, as opposed to just the number of object users who voted for the object.

The present invention also provides an objective, quantified method and apparatus to compare popularity levels for multiple objects, and use those to sort or rank those objects. Such rankings can be used to highlight the most popular content.

The popularity indicator of an object also provides value on its own, without comparison to popularity indicators of other objects. For example, it can be displayed for a single object to quickly highlight the popularity of that object one can state that a book “was shared by users with 124,328 of their friends on Facebook”, which constitutes valuable information in itself.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Embodiments of the invention also include computer program products for performing various operations disclosed herein. The computer program products comprises program code that may be embodied on a tangible computer-readable or accessible storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. One or more parts of the program code may be distributed as part of an appliance, downloaded, and/or otherwise provided to a customer.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

### Method for Object-Specific Indicator of User Influence

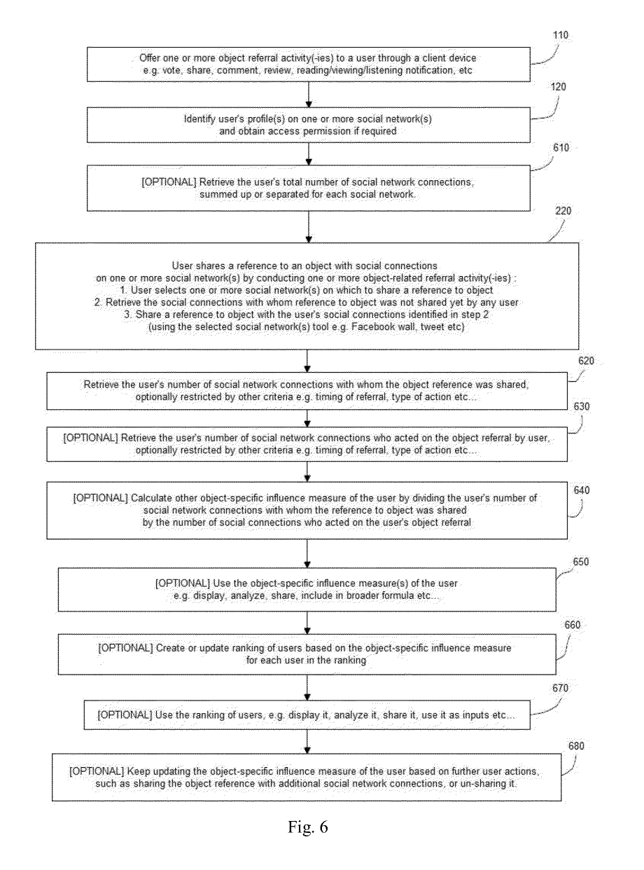

FIG. 6 is a flow chart illustrating an exemplary process for creating or updating an indicator communicating object-specific measures of a user influence, based on the number of social network connections with whom the user shared a reference to the object.

Acts 110, 120 and 220 are explained in FIG. 1 and FIG. 2 descriptions above.

At optional act 610, the number of social network connections of the user on one or more social network(s) is retrieved from the social network(s) 340 and stored in the memory of web server 330, the application server 370, data storage 380 or any other storage method. When users can choose to refer an object to only some of their social connections, the data can be used in conjunction with the data returned by act 620 to compare actual social reach to potential social reach by one or more users for a given object. The total number of social network connections with whom an object was shared by users can be retrieved and compared to the total number of social network connections of those users. It can help discover that users chose to share an object with, for example, only 40% of their social network connections. Based on the social reach data available, additional analysis could then be conducted to assess what type of social network connections the users chose to refer the object to, and further refine a popularity indicator to carry and communicate that information.

The data retrieved through act 610 can also be presented to the user, either as the sum of all social network connections across all networks; or separately as the numbers of connections on each social network. In an exemplary embodiment, the data retrieved can be restricted by additional criteria related to the type of relationships with the user or to the social network connections' profiles. For example, the number presented could be the sum of only those social network connections with whom a reference to the object has been shared on Twitter, and who have published more than ten tweets through their Twitter profile. One of ordinary skill in the art would appreciate that there are numerous criteria that could be utilized for this purpose in accordance with embodiments of the present invention, and embodiments of the present invention are contemplated for use with any appropriate criteria.

At act 620, the number of social network connections to whom the user referred the object is retrieved, optionally restricted by other criteria e.g. timing of referral, type of action etc. . . . . That data can be retrieved from the social networks) through an Application Programming Interface (API) call for example (when such data is shared by the social network), or directly from a database if accessible (for example because the social network is administered directly by the provider of the object-specific user influence indicator). The data is stored in the memory of web server 330 or application server 370, data storage 380, and/or client device 310 (for example on a cookie 311), and constitutes an indicator of user influence for the object.

At optional act 630, the user's number of social network connections who acted on the object referral by user is retrieved, optionally restricted by other criteria e.g. timing of referral, type of action etc. . . . . That data can be retrieved from the social network(s) through an API call for example (when such data is shared by the social network), or directly from a database if accessible (for example because the social network is administered directly by the provider of the object-specific user influence indicator). The data is stored in the memory of web server 330 or application server 370, data storage 380, and/or client device 310 (for example on a cookie 311), and constitutes an indicator of user influence for the object. Act 630 can occur at any point between act 220 and act 640, and is required to complete act 640.

At optional act 640, another indicator of user influence for the object is calculated by dividing the number of social connections who acted on the user's object referral (retrieved through act 630) by the user's number of social network connections with whom the reference to the object was shared (retrieved through act 620, which is a requirement for act 640). The resulting data is stored in the memory of web server 330, application server 370, data storage 380, and/or client device 310 (for example on a cookie 311).

At optional act 650, one or several of the indicators of user influence for the object, generated through act(s) 620, 630 and/or 640 is (are) used, for example by being displayed on a computer screen, printed, analyzed, shared on social networks, or used as input(s) into another algorithm. In one embodiment, the object-specific influence indicator values for a user at different points in time can be compared to assess changes in influence level for that object, and identify the users whose influence for that object is increasing the fastest, with the resulting analysis being shared through an electronic newsletter.

At optional act 660, several users of an object (or a group of objects) are ranked or sorted using their object-specific influence indicators (or an average, sum or other aggregated measure thereof when considering groups of objects). If the ranking or sorting already existed, it is updated. For instance, users can be ranked from most influential to least influential for the referral of a song by the band “U2” by comparing their influence indicator values for that song. The most influential user for all of the songs of U2 could also be identified by comparing each user's influence indicator values expressed as total number of social network connections to whom a U2 song was referred by the user. In another example, an influence ranking of users who shared a referral, for example for a TV dance contest program, with more than 5,000 social network connections, may be computed by sorting those users by the percentage of friends who visited a given webpage after clicking on the link for that page in the referrals by the user.

At optional act 670, the ranking or sorting created in act 660 is used, for example by being displayed on a computer screen, printed, analyzed, shared on social networks, or used as inputs into another algorithm.

Act 680 is to keep updating the object-specific influence indicator of the user based on further user actions, such as sharing the object reference with additional social network connections, or un-sharing it. The user influence indicator can be updated dynamically, for example by monitoring changes in the number of social network connections to whom the user referred the object, or changes in the social network connections' profile data used to compute the user influence indicator (for example, if only Canadian residents counted towards the user influence indicator, any social network connection changing its residence from Canada to another country may be deducted from the variable(s) used to compute the popularity indicator). If a user “un-shares” an object previously shared on a social network, the number of social network connections with whom the object was unshared can also be updated in the computation of the user influence indicator for that object.

The update action can be triggered by certain events, such as a user request to see an object-specific user influence indicator, or a social network notification that an item was un-shared; changes can also be monitored periodically, for example by making an API call to the social network(s) automatically every half-hour to retrieve a user's social reach data for instance including the IDs of the social network connections to whom the object was referred, and compare that to an earlier version of the data to highlight any change.

When a user refers an object several times to the same social connection(s), each referral may count towards the object-specific influence indicator of the user. In a preferred embodiment, only one referral by social network connection counts.

The process described in FIG. 6 can be repeatedly applied to multiple objects referred by a user. The result is an indicator of the influence of the user for a range of objects, which can be a useful indicator of the influence of the user in given object category, or even overall. When applied to multiple users, the process can be used to generate influence rankings of users by category or overall.

The present invention thus makes it possible to assess the referral conversion power of a given user for a particular object, and compare it to that of other users, by measuring and comparing the numbers or percentages of social network connections who acted on a referral for that object by each user. For example, 3% of social network connections, e.g. Twitter followers, may click on a link for a newspaper article as a result of a tweet by user A, whereas 25% may click on the same link as a result of a tweet by user B. In that scenario, the total number of followers for users A and B are retrieved at the time of referral sharing (i.e. tweeting about the object, in that scenario), as well as the number of followers who clicked on the link (if available, in the present example either through Twitter's API or through web statistics from the link's destination).

With this invention, the influence of a given user can thus be assessed for different objects or categories of objects, and compared. For example, using the present invention, one may find that 7% of a user's social network connections may buy Justin Timberlake's songs when referred to by that user, whereas only 1% of them may buy Justin Bieber's songs referred to by that same user.

The process described in FIG. 6 can also be adapted easily to assess the performance of different types of referrals for a given object or group of objects, for example by comparing the overall user influence for an object over different social networks. The result is an indicator of the influence of a social network for an object or group of objects. When applied to multiple social networks, the process can be used to generate influence rankings of social network by object, category or overall.

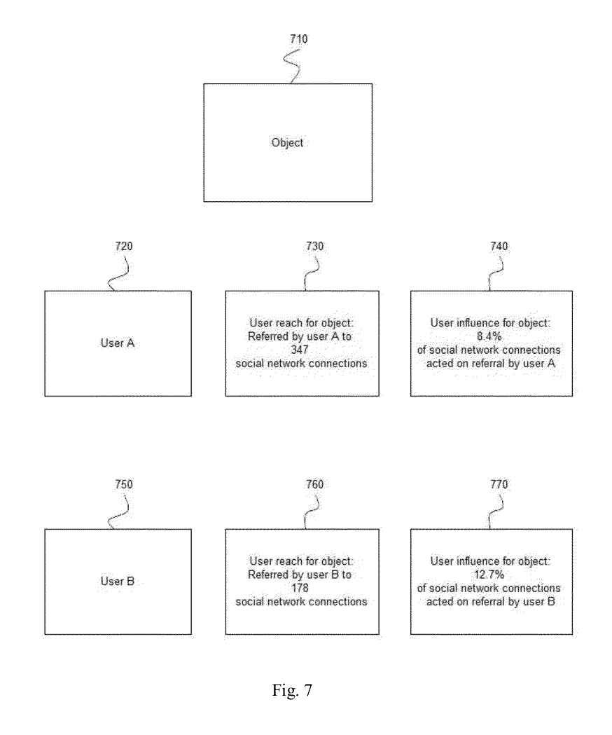

FIG. 7 is an example of indicator displaying object-specific measures of a user influence, generated through the method described in FIG. 6, and displayed on a webpage.

Object 710 is a computer-based object or computer-based reference to an object, as previously described in the terminology note for “object”. For example, it could be an MP3 file, a link to cars for sale, to fashion designers' Facebook pages, or any other online reference to an object. It is or links to the object to which the user influence indicators 730, 740, 750 and 760 refer to.

User A 720 and user B 750 are distinct users (or two separate profiles for a unique user) who referred object 710 to social network connections through an object-specific referral action as described in act 110.

User influence scores 730 and 760 are user influence indicators for the object 710, based on the respective social reach data of the object users 720 and 750. Score 730 is the total number of social network connections to whom an object was referred to by user A 720. Optionally, the number could also be narrowed down using additional social reach data based on the social network connections' relationships with user A 720 or the social network connection profiles if accessible (e.g. minimum age, or type of social network connection). Score 760 is the total number of social network connections to whom an object was referred to by user B 750. In this example, user A 720 has referred object 710 to 347 social network connections, a higher number than user B 750, who referred object 710 to 178 social network connections.

User influence scores 740 and 770 are different user influence indicators for the object 710, also based on the respective social reach data of the object users 720 and 750. Score 740 is the percentage of social network connections of the object users who acted on the object referral by the users, for example by buying the object as a result, clicking on a link within the referral, or “liking” the referral if in Facebook. In this example, a higher percentage (12.7%) of the social network connections to whom user B 750 referred object 710 acted on the referral than for the social network connections to whom user A 720 referred object 710 (8.4%).

In other embodiments, and not by way of limitation, user influence scores 730, 740, 760 and 770 may each be independently displayed as text expression, symbol or graph. They could also be communicated through sounds instead of visual symbols.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

### Social Network Referral-Based Commercial Incentive Method

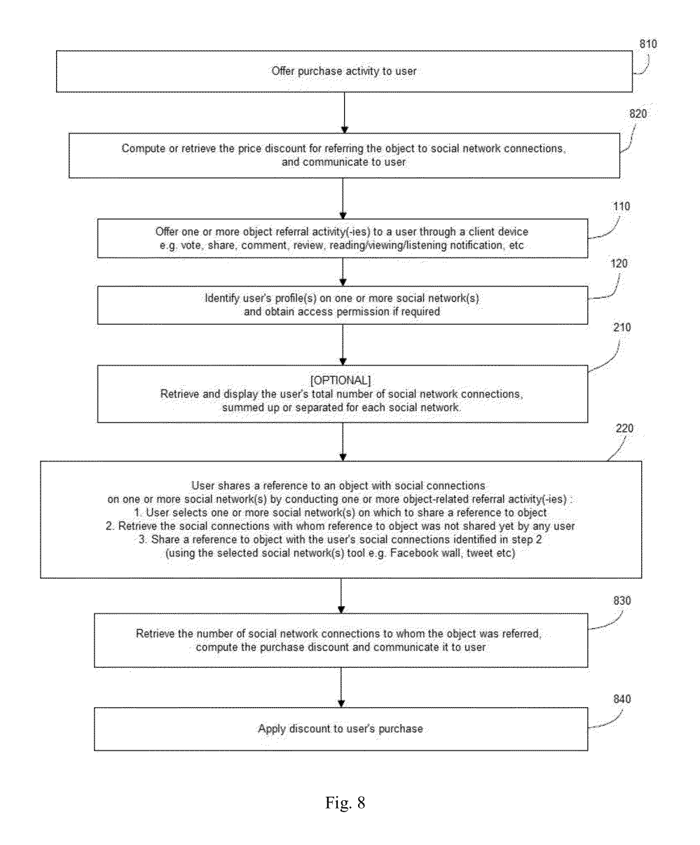

FIG. 8 is a flow chart illustrating an exemplary process for offering a commercial discount, based on the number of social network connections with whom the user shared a reference to the object.

At act 810, a purchase activity is offered to the user. For example, a concert ticket is presented for sale on a mobile application. Or a software solution with a monthly subscription fee. The price may or may not be communicated to the user at that point. In a preferred embodiment, the purchase activity is offered online, often through a page displaying a description of the object. It is possible however to offer the purchase activity offline and couple it with the incentives presented in this invention. One of ordinary skill in the art would appreciate that this offering may take place entirely online, entirely offline or by having some portion occurring online and another portion occurring offline.

At act 820, a price discount is retrieved from memory or data storage 380 and/or computed by web server 330 or application server 370, based on a fixed or computed number of social network connections to which an object can be referred. The price discount is then communicated to the user, along with the referral action required to obtain it. For example, the user could be informed that she will receive a 10% discount on the concert ticket if she refers the concert to more than 100 social network connections on Google+. Or an extra 1% discount for each 15 social network connections to whom she refers the object, up to a maximum 15% discount. The object on which the referral is requested and the object on which the discount is offered do not need to be the same. In the example above, the discount on the concert ticket could be tied to referring the ticket-selling website or a song to her social network connections instead of referring the concert. In another embodiment, referrals of multiple objects across multiple social networks may be requested.

Acts 110, 120, 210, and 220 are explained in the FIG. 1 and FIG. 2 descriptions above.

At act 830, the number of social network connections to whom the object was referred is retrieved from social network(s) 340; the web server 330 or application server 370 checks whether the conditions for extending the purchase discount to the user were met; and the discount level may optionally be communicated to the user.

Other conditions based on the social network connections to whom the object was referred may be required in addition to or in lieu of the threshold number of social network connections to refer the object to. For example, the social network connections may only be counted if they acted on the referral (e.g. by re-sharing it, liking it in Facebook, or clicking on a link within the referral), if they hold a certain type of relationship with the user (e.g. friendship, romantic relationship, business relationships, acquaintances, common interest relationship), or if they meet certain profile criteria (e.g. living in Hawaii). Of course, those conditions assume that the corresponding data is available from the applicable social network(s). On Twitter, the condition could for instance include whether a social connection re-tweeted the referral or clicked on a link within the referring tweet, data from the followers' Twitter profiles, or information on the type of connection they have with the object user (which may be gathered from Twitter lists for example). Those examples are based on the current structure of those social networks and are susceptible to change over time, so the definition of social reach data should be interpreted conceptually, without being limited by the examples above. One of ordinary skill in the art would appreciate that changes in the definition of social reach date do not exceed the scope and spirit of this invention, and it is intended for this invention to allow for dynamic interpretation of social reach data.

At act 840, the price discount is applied to the purchase by user. That act is dependent upon the conditions for the discount being met, and the user completing the purchase activity.

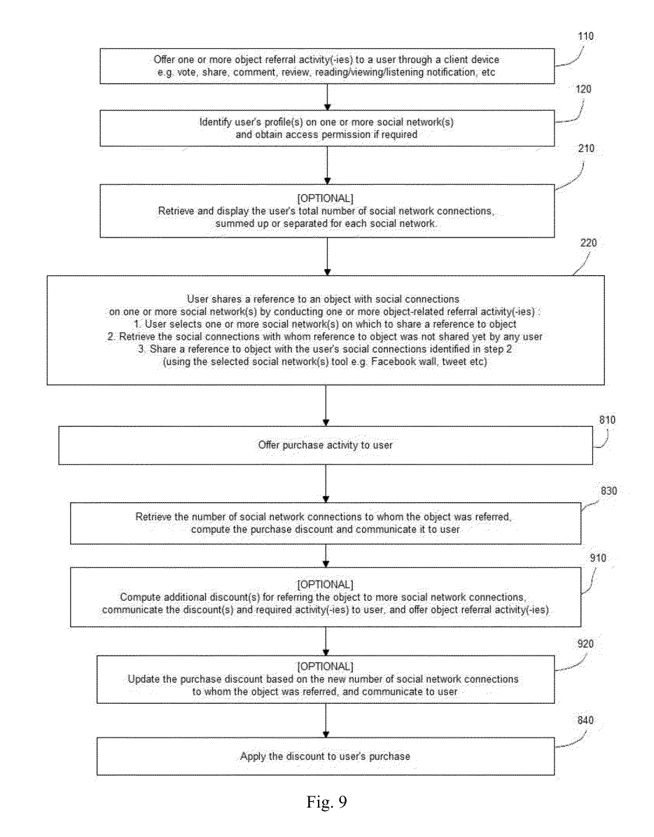

FIG. 9 is a flow chart illustrating another embodiment of the process for offering a commercial discount, based on the number of social network connections with whom the user shared a reference to the object.

In the embodiment illustrated by FIG. 9, the user refers an object to social network connections prior to a purchase activity and purchase discount are offered. Thus, a discount may be extended after the user has referred the object to social network connections, possibly without the knowledge of the existence of a commercial incentive.

At act 830; the price discount is calculated based on the referral activity completed by the user prior to a purchase activity being offered.

At optional act 910, one or more additional price discount(s) are computed based on a fixed or computed number of social network connections to which an object can be referred. The price discounts) is/are then communicated to the user, along with the referral action required to obtain it. For example, the user could be informed that she will receive an extra $5 discount for each additional 100 social network connections to whom he refers the object. The corresponding object referral activity is offered to the user, for example through a clickable link that leads to a referral interface similar to pop-up screen 430.

At optional act 920, the number of social network connections to whom the object was referred is retrieved from social network(s) 340, along with any other social reach data required to assess whether the conditions for extending the discount were met (e.g. similar conditions to those presented under the above description of act 830). The web server 330 or application server 370 checks whether the conditions for extending the purchase discount to the user were met, and computes the discount to be extended. The discount can then optionally be communicated to the user. Act 920 requires act 910.

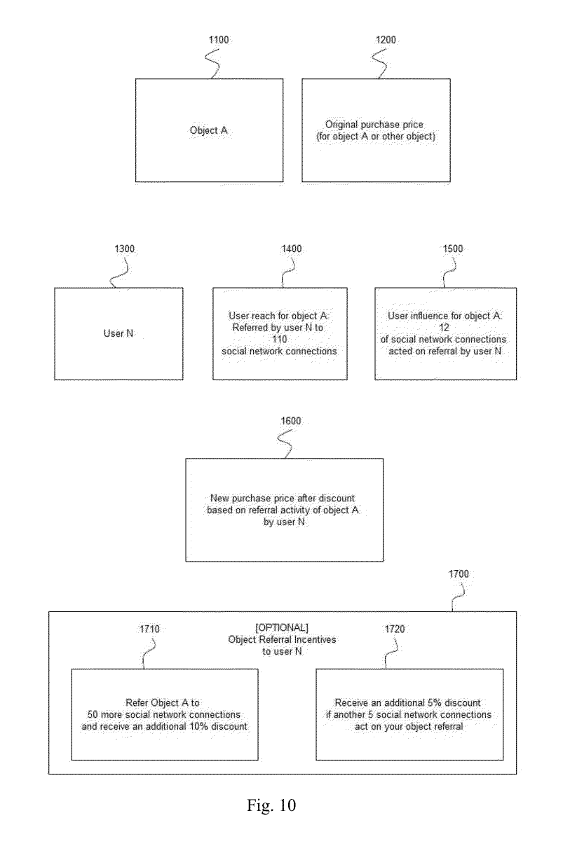

FIG. 10 is an exemplary embodiment of a screen display for the commercial discounting method described in FIGS. 8-9, and communicated on a mobile webpage.

In the example presented in FIG. 10, purchase and referral incentives based on an object referral to social network connections may be shown after (as per method in FIG. 8) or before (as per method in FIG. 9) a user has started to refer the object to social network connections.

Object A 1100 is a computer-based object or computer-based reference to an object, as previously described in the terminology note for “object”. For example, it could be a picture, a link to paintings for sale, or any other online reference to an object.

Original purchase price 1200 is the price of the object offered for purchase to user N. That object may be object A or a different object.

User N 1300 is a user who referred or may refer object A 1100 to social network connections through an object-specific referral action as described in act 110.

Object-specific user influence indicator 1400 for object A is an indicator created using act 620. The indicator exists if user N 1300 has already referred object A 1100 to social networks connections. In the example presented in FIG. 10, user N 1300 has referred object A 1100 to 110 social networks connections.

Object-specific user influence indicator 1500 for object A is an indicator created using act 630 or 640. In the example presented in FIG. 10, it was created using act 630. The indicator exists if user N 1300 has already referred object A 1100 to social networks connections, and data can be collected on whether social network connections acted on the referral. In the example presented in FIG. 10, 12 social networks connections have acted on the referral of object A 1100 by user N 1300.

New purchase price 1600 is the price offered for purchase to the user, which is original purchase price 1200 less a discount based on the referral activity of user N. For example, if referring object A to more than 100 social network connections entitled a user to receive a 5% discount on the object offered for purchase to user N, the new purchase price 1600 is original purchase price 1200 less a 5% discount. Note that instead of a price discount, another commercial incentives may be provided, for example a free subscription to another service or an accessory to the object offered for purchase to user N.

Additional referral incentives 1700 may be offered to user N for encouraging additional referral activity. To receive an additional commercial reward, user N may refer object A (or another object) to additional social network connections. Those social network connections may be on the same social network(s) on which user N recommended object A (assuming the object was not already referred to all of user N's social connection on those networks—and unless multiple referrals to the same social network connection is possible and desirable), or on other social networks. In referral incentive 1710 for example, user N is offered an additional 10% discount for referring object A to 50 additional social network connections. Referral incentive 1720 provides user N with an extra 5% discount if another 5 social network connections act on existing or new referrals by user N. Any incentive linking a commercial reward with object referrals by a user to her/his social network connections are possible.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that there is no need for embodiments of the present invention to control the referral mechanisms or even provide an object referral mechanism. Such claim limitations are inserted only as a guide and an entrance point into the invention. Embodiments of the present invention are contemplated for use without any offering of an object referral activity.

What is claimed is:

1. A computer-implemented method for creating a popularity indicator for an object (defined as an entity that may be referred or shared on a social network, such as one or more of a file, a music piece, a video, a photograph, a picture, an article, a discussion, a post, a group of text, a user comment, a user profile, user data, a link to another page, a link to another application, a link to a file, a file, a document, or a community) based on the number of social network connections to whom the object was referred, the method comprising:
offering one or more object referral activities to a user over a network;
identifying the user and obtaining access to required social reach data on one or more social networks;
retrieving a number from said one or more social networks, wherein said number represents social network connections with whom the user shared a reference to the object on one or more social networks, optionally meeting one or more conditions based on the social network connection's social profile, the type or timing of the referral, whether the social network connection further acted on the referral, or a combination thereof;
creating the popularity indicator of the object based at least in part on said number; and
generating code for, when executed, displaying the popularity indicator of the object on a client device, using it as a variable for further computer-based processing operations, or storing, in a tangible storage medium, the resulting value(s).

2. The computer-implemented method of claim 1, further comprising the steps of:
receiving a query for objects;
retrieving objects with their respective popularity indicators; and
generating code for, when executed, displaying some or all of the retrieved objects sorted by popularity indicators or using their popularity indicators as variables for further computer-based processing operations.

3. The computer-implemented method of claim 1, further comprising the step of measuring quantitative changes in the popularity indicator of the object over a given period in order to update the popularity indicator of the object, provide an assessment of changes in popularity, or extrapolate those changes to provide an assessment of future popularity levels, using one or more extrapolation techniques.

4. A computer-implemented method for creating a user influence indicator for one or more objects (defined as an entity that may be referred or shared on a social network, such as one or more of a file, a music piece, a video, a photograph, a picture, an article, a discussion, a post, a group of text, a user comment, a user profile, user data, a link to another page, a link to another application, a link to a file, a file, a document, or a community), based on a number of social network connections to whom the object(s) was (were) referred, the method comprising:
offering one or more object referral activities to a user through a network;
identifying the user and obtaining access to required social reach data on one or more social networks;
retrieving a number from said one or more social networks, wherein said number represents social network connections with whom the user shared a reference to the object(s) on one or more social networks, optionally meeting one or more conditions based on the social network connection's social profile, the type or timing of the referral, whether the social network connection further acted on the referral, or a combination thereof;
creating the object-specific influence indicator of the user based at least in part on said number; and
generating code for, when executed, displaying the object-specific influence indicator of the user on a client device, using it as a variable for further computer-based processing operations, or storing, in a tangible storage medium, the resulting value(s).

5. The computer-implemented method of claim 4, further comprising the steps of
receiving a query for users;
retrieving users with their respective object-specific influence indicators; and
generating code for, when executed, displaying some or all of the retrieved users sorted by object-specific influence indicator or using their influence indicators as variables for further computer-based processing operations.

6. The computer-implemented method of claim 4, further comprising the step of measuring quantitative changes in the object-specific influence indicator of the user over a given period in order to update the object-specific influence indicator of the user, provide an assessment of changes in influence, or extrapolate those changes to provide an assessment of future popularity levels using one or more extrapolation techniques.

7. The method of claim 4, further comprising the steps of:
communicating over a social network or any other media a commercial reward incentive (such as a price discount on a purchase activity, or any other commercial incentive) to said user;
computing data on the commercial reward based on the object-specific influence indicator of the user and one or more conditions for applying the commercial reward;
generating code for, when executed, displaying the said data on a client device, using it as a variable for further computer-based processing operations, or storing, in a tangible storage medium, the resulting value(s); and
optionally generating code for, when executed, applying the commercial reward.

8. A computer-implemented method for creating an indicator consisting of a number of social network connections to whom a user could refer a given object on one or more social networks, the method comprising:
identifying and accessing required user's social reach data on one or more social networks;
retrieving a number from said one or more social networks, wherein said number represents social network connections with whom the user shared a reference to the object on one or more social networks, optionally meeting one or more conditions based on the social network connection's social profile, the type of relationship between the social connections and the use, or a combination thereof; and
generating code for, when executed, displaying the said number on a client device, using it as a variable for further computer-based processing operations, or storing, in a tangible storage medium, the resulting value(s).

9. The method of claim 8, further comprising the steps of:
offering one or more object referral activities to one or more users over one or more social networks;
retrieving a number representing the social network connections with whom the object was shared by said one or more users, or only those social network connections who acted on the object referral;
calculating an object-specific influence indicator of the said one or more users based at least in part on the number representing the proportion of social network connections with whom the object was shared by said one or more users or only those social network connections who acted on the object referral, out of all the social network connections of said one or more users or on only those social network connections with whom said one or more users shared a reference to the object; and
generating code for, when executed, displaying the object-specific influence indicator on a client device, using it as a variable for further computer-based processing operations, or storing, in a tangible storage medium, the resulting value(s).

10. The method of claim 8, further comprising the steps of:
offering one or more object referral activities to said user over one or more social networks;
communicating over a social network or any other media a commercial reward incentive (such as a price discount on a purchase activity, or any other commercial incentive) to said user;
retrieving a number representing social network connections of said user who acted on the object referral;
calculating an object-specific influence indicator of said user based at least in part on the number representing the proportion of social network connections with whom the object was shared by said user or only those social network connections who acted on the object referral, out of all the social network connections of said user or on only those social network connections with whom said user shared a reference to the object;
computing data on the commercial reward based on the number above and one or more conditions for applying the commercial reward;
generating code for, when executed, displaying the said data on a client device, using it as a variable for further computer-based processing operations, or storing, in a tangible storage medium, the resulting value(s); and
optionally generating code for, when executed, applying the commercial reward.

11. A computer program product for creating a popularity indicator for an object (defined as an entity that may be referred or shared on a social network, such as one or more of a file, a music piece, a video, a photograph, a picture, an article, a discussion, a post, a group of text, a user comment, a user profile, user data, a link to another page, a link to another application, a link to a file, a file, a document, or a community) based on the number of social network connections to whom the object was referred, the method comprising:
offering one or more object referral activities to a user over a network;
identifying the user and obtaining access to required social reach data on one or more social networks;
retrieving a number from said one or more social networks, wherein said number represents social network connections with whom the user shared a reference to the object on one or more social networks, optionally meeting one or more conditions based on the social network connection's social profile, the type or timing of the referral, whether the social network connection further acted on the referral, or a combination thereof;
creating the popularity indicator of the object based at least in part on said number, and
generating code for, when executed, displaying the popularity indicator of the object on a client device, using it as a variable for further computer-based processing operations, or storing, in a tangible storage medium, the resulting value(s).

12. The computer program product of claim 11, further comprising the steps of:
receiving a query for objects;
retrieving objects with their respective popularity indicators; and
generating code for, when executed, displaying some or all of the retrieved objects sorted by popularity indicators or using their popularity indicators as variables for further computer-based processing operations.

13. The computer program product of claim 11, further comprising the step of measuring quantitative changes in the popularity indicator of the object over a given period in order to update the popularity indicator of the object, provide an assessment of changes in popularity, or extrapolate those changes to provide an assessment of future popularity levels, using one or more extrapolation techniques.

14. A computer program product for creating a user influence indicator for one or more objects (defined as an entity that may be referred or shared on a social network, such as one or more of a file, a music piece, a video, a photograph, a picture, an article, a discussion, a post, a group of text, a user comment, a user profile, user data, a link to another page, a link to another application, a link to a file, a file, a document, or a community), based on a number of social network connections to whom the object(s) was (were) referred, the method comprising:
offering one or more object referral activities to a user through a network;
identifying the user and obtaining access to required social reach data on one or more social networks;
retrieving a number from said one or more social networks, wherein said number represents social network connections with whom the user shared a reference to the object(s) on one or more social networks, optionally meeting one or more conditions based on the social network connection's social profile, the type or timing of the referral, whether the social network connection further acted on the referral, or a combination thereof;
creating the object-specific influence indicator of the user based at least in part on said number; and
generating code for, when executed, displaying the object-specific influence indicator of the user on a client device, using it as a variable for further computer-based processing operations, or storing, in a tangible storage medium, the resulting value(s).

15. The computer program product of claim 14, further comprising the steps of:
receiving a query for users;
retrieving users with their respective object-specific influence indicators; and
generating code for, when executed, displaying some or all of the retrieved users sorted by object-specific influence indicator or using their influence indicators as variables for further computer-based processing operations.

16. The computer program product of claim 14, further comprising the step of measuring quantitative changes in the object-specific influence indicator of the user over a given period in order to update the object-specific influence indicator of the user, provide an assessment of changes in influence, or extrapolate those changes to provide an assessment of future popularity levels using one or more extrapolation techniques.

17. The computer program product of claim 14, further comprising the steps of:
communicating over a social network or any other media a commercial reward incentive (such as a price discount on a purchase activity, or any other commercial incentive) to said user;
computing data on the commercial reward based on the object-specific influence indicator of the user and one or more conditions for applying the commercial reward;
generating code for, when executed, displaying the said data on a client device, using it as a variable for further computer-based processing operations, or storing, in a tangible storage medium, the resulting value(s); and
optionally generating code for, when executed, applying the commercial reward.

18. A computer program product for creating an indicator consisting of a number of social network connections to whom a user could refer a given object on one or more social networks, the method comprising:
identifying and accessing required user's social reach data on one or more social networks;
retrieving a number from said one or more social networks, wherein said number represents social network connections with whom the user shared a reference to the object on one or more social networks, optionally meeting one or more conditions based on the social network connection's social profile, the type of relationship between the social connections and the use, or a combination thereof; and
generating code for, when executed, displaying the said number on a client device, using it as a variable for further computer-based processing operations, or storing, in a tangible storage medium, the resulting value(s).

19. The computer program product of claim 18, further comprising the steps of:
offering one or more object referral activities to one or more users over one or more social networks;
retrieving a number representing the social network connections with whom the object was shared by said one or more users, or only those social network connections who acted on the object referral;
calculating an object-specific influence indicator of the said one or more users based at least in part on the number representing the proportion of social network connections with whom the object was shared by said one or more users or only those social network connections who acted on the object referral, out of all the social network connections of said one or more users or on only those social network connections with whom said one or more users shared a reference to the object; and
generating code for, when executed, displaying the object-specific influence indicator on a client device, using it as a variable for further computer-based processing operations, or storing, in a tangible storage medium, the resulting value(s).

20. The computer program product of claim 18, further comprising the steps of:
offering one or more object referral activities to said user over one or more social networks;
communicating over a social network or any other media a commercial reward incentive (such as a price discount on a purchase activity, or any other commercial incentive) to said user;
retrieving a number representing social network connections of said user who acted on the object referral;
calculating an object-specific influence indicator of said user based at least in part on the number representing the proportion of social network connections with whom the object was shared by said user or only those social network connections who acted on the object referral, out of all the social network connections of said user or on only those social network connections with whom said user shared a reference to the object;
computing data on the commercial reward based on the number above and one or more conditions for applying the commercial reward;
generating code for, when executed, displaying the said data on a client device, using it as a variable for further computer-based processing operations, or storing, in a tangible storage medium, the resulting value(s); and
optionally generating code for, when executed, applying the commercial reward.
